(19) United States
(12) Patent Application Publication
(10) Pub. No.: US 2023/0252995 A1
(43) Pub. Date: Aug. 10, 2023

(54) ALTERING A CANDIDATE TEXT REPRESENTATION, OF SPOKEN INPUT, BASED ON FURTHER SPOKEN INPUT

(71) Applicant: GOOGLE LLC, Mountain View, CA (US)

(72) Inventors: Matthew Sharifi, Kilchberg (CH); Victor Carbune, Zurich (CH); Bogdan Prisacari, Adliswil (CH); Alexander Froemmgen, Zurich (CH); Milosz Kmieciak, Zurich (CH); Felix Weissenberger, Zurich (CH); Daniel Valcarce, Zurich (CH)

(21) Appl. No.: 17/667,314

(22) Filed: Feb. 8, 2022

(51) Int. Cl. G10L 15/26; G10L 15/22; G10L 15/08; G10L 15/06

(52) U.S. Cl. CPC G10L 15/26; G10L 15/22; G10L 15/08; G10L 15/063; G10L 2015/088

(57) ABSTRACT

Various implementations include determining whether further spoken input is intended to correct at least one word in a candidate text representation of spoken input. Various implementations include receiving audio data capturing spoken input of a user. Various implementations include rendering output based on the candidate text representation to the user. Various implementations include receiving, while the output is being rendered, further audio data capturing the further spoken input. In response to determining the further spoken input is intended to correct the at least one word in the candidate text representation, various implementations include generating a revised text representation of the spoken input by altering at least one word in the candidate text representation based on one or more terms in the further candidate text representation.

### BACKGROUND

Humans may engage in human-to-computer dialogs with interactive software applications referred to herein as “automated assistants” (also referred to as “chatbots,” “interactive personal assistants,” “intelligent personal assistants,” “personal voice assistants,” “conversational agents,” etc.). Automated assistants typically rely upon a pipeline of components in interpreting and responding to spoken utterances (or touch/typed input). For example, an automatic speech recognition (ASR) engine can process audio data that correspond to a spoken utterance of a user to generate ASR output, such as one or more speech hypotheses (i.e., sequence of term(s) and/or other token(s)) of the spoken utterance or phoneme(s) that are predicted to correspond to the spoken utterance. Further, a natural language understanding (NLU) engine can process the ASR output (or the touch/typed input) to generate NLU output, such as an intent of the user in providing the spoken utterance (or the touch/typed input) and optionally slot value(s) for parameter(s) associated with the intent. Moreover, a fulfillment engine can be used to process the NLU output, and to generate fulfillment output, such as a structured request to obtain responsive content to the spoken utterance and/or perform an action responsive to the spoken utterance, and a stream of fulfillment data can be generated based on the fulfillment output.

Generally, a dialog session with an automated assistant is initiated by a user providing a spoken utterance, and the automated assistant can respond to the spoken utterance using the aforementioned pipeline of components to generate a response. The user can continue the dialog session by providing an additional spoken utterance, and the automated assistant can respond to the additional spoken utterance using the aforementioned pipeline of components to generate an additional response. Put another way, these dialog sessions are generally turn-based in that the user takes a turn in the dialog session to provide a spoken utterance, and the automated assistant takes a turn in the dialog session to respond to the spoken utterance when the user stops speaking.

### SUMMARY

Implementations described herein are directed towards determining whether to correct one or more words, in a candidate text representation of spoken input, based on a further candidate text representation of further spoken input, where the spoken input and the further spoken input are both spoken by the same user in a dialog session. For example, a user can speak the spoken input of “what is a vat”. However, when generating a candidate text representation of the spoken input, in some instances the system can misrecognize the word ‘vat’ and generate the incorrect candidate text representation of “what is a hat”. In some implementations, the system can render output to the user based on the incorrect candidate text representation of “what is a hat”. For example, the system can render a transcript (e.g., a streaming transcript) of the candidate text representation of “what is a hat” and/or rendering a response generated based on the candidate text representation of “what is a hat” (e.g., an audible response that includes a definition of a “hat” and/or a visual response that includes an image of a “hat”). Such output enables the user to ascertain the misrecognition of the word ‘vat’ during the dialog session. The user can then correct the misrecognition by speaking further spoken input of “with a V”. In some implementations, the system can determine, based on a further candidate text representation of the further spoken input of “with a V”, whether the further spoken input was spoken by the user to correct one or more words in the candidate text representation of the spoken input. For example, based on the further candidate text representation of “with a V”, the system can determine whether the further spoken input was spoken to correct the candidate text representation of the prior spoken input or, instead, was provided as a continuation of the user utterance, a separate stand-alone spoken request to the system, and/or was provided as a spoken request not intended for the system (e.g., directed instead to another co-present human). Additionally or alternatively, the system can correct the misrecognition of the word “vat”, based on the further candidate text representation of “with a V”, to generate a revised text representation of “what is a vat” (i.e., that includes “vat” in lieu of “hat”).

In some implementations, the system can determine whether the further candidate text representation was intended to correct at least one word in the candidate text representation based on processing the further candidate text representation (and/or the audio data capturing the further spoken input) using a disambiguation model. In some implementations, the disambiguation model can be trained to process the further candidate text representation to identify whether any of one or more grammars are present in the further candidate text representation. For example, the grammar(s) can include ‘ends with <entity>’, ‘begins with <entity>’, ‘with a <entity>’, ‘like <entity>’, one or more additional or alternative grammars, and/or combinations thereof. Additionally or alternatively, the disambiguation model can be trained to process the further candidate text representation to identify whether the candidate text representation includes a reference to one or more specific entities (e.g., actors, places, book characters, artists, musicians, one or more alternative specific entities, and/or combinations thereof), and/or other categories (e.g., animal, movie star, food, one or more alternative specific entities, and/or combinations thereof). For example, the system can process the further candidate text representation of “with a V” to identify the grammar ‘with a <entity>’. Additionally or alternatively, the system can identify one or more attributes corresponding to the <entity> portion of the grammar, such as identifying one or more attributes corresponding to ‘V’ of the further candidate text representation of “with a V”.

In some implementations, the system can identify one or more attributes in the further candidate text representation of the further spoken input. The one or more attributes can include pronunciation clues (e.g., ‘with a V’, ‘starting with a B’, ‘ending with a P’, etc.); knowledge graph entities (e.g., ‘as in Walter P. Cunningham’, where ‘Walter P. Cunningham is a famous actor’, etc.); other types of categories (e.g., ‘not the animal’, ‘the movie star’, etc.); and/or combinations thereof. For example, the further spoken input of “with a V” includes one or more attributes based on ‘V’; the further spoken input of “like Brad the Big Green Cat” includes one or more attributes based on ‘Brad the Big Green Cat’; and the further spoken input of “ends with a P” includes one or more attributes based on ‘P’. In some implementations, the system can compare the one or more attributes with the candidate text representation of the spoken input and/or one or more additional hypotheses for the candidate text representation of the spoken input. For instance, the system can compare one or more low confidence terms, one or more infrequently used terms, one or more infrequently used entity names, one or more additional terms, and/or combinations thereof with the one or more attributes. For example, the system can identify a low confidence term of ‘hat’ in the candidate text representation of the spoken input of “what is a hat”, and the system can identify one or more attributes based on ‘V’ in the further text representation of “with a V”. In some implementations, the system can determine to apply the one or more attributes based on ‘V’ to the word ‘hat’ based on the low confidence the system has in the word hat, and can generate the revised text representation of “what is a vat”.

In some implementations, the system can determine whether the user spoke the further spoken input as a correction, of the previous spoken utterance, based on comparing the one or more attributes of the further candidate text representation with the candidate text representation (and/or one or more additional hypotheses of the candidate text representation). For example, the system can compare the one or more attributes of the further candidate text representation with one or more low confidence words, infrequently used terms, infrequently used entity names, one or more additional terms, and/or combinations thereof in the candidate text representation and/or the additional hypotheses of the candidate text representation. In some implementations, each word in the candidate text representation can have a corresponding confidence score indicating the likelihood that the candidate word was spoken by the user in the spoken input.

As a particular example, the system can determine a confidence score corresponding to the word ‘hat’ in the candidate text representation of “what is a hat”, where the word ‘hat’ is a misrecognition of the word ‘vat’ in the spoken input. The system can determine the further spoken input of “with a V” was intended to correct the word ‘hat’ based on a low confidence score of the word ‘hat’ in the candidate text representation. In some of those implementations, the system can generate a revised text representation of the spoken input of “what is a vat” by altering the word ‘hat’ in the candidate text representation based on the attribute “v” in the further spoken input “with a v”. Conversely, the system can determine the further spoken input of “with a V” was not intended to correct the word ‘hat’ based on a high confidence score of the word ‘hat’ in the candidate spoken input.

In some implementations, the system can rescore one or more hypotheses of the candidate text representation based on the further spoken input. For example, the system can rescore the one or more hypotheses based on the underlying confidence of a term in the spoken input and a relatedness score of the further spoken input indicating a likelihood the further spoken input is related to the term in the spoken input. For instance, when generating the candidate text representation of the spoken input of “what is a hat” (i.e., the top hypothesis of the text representation of the spoken input), the system can generate additional hypotheses of “what is a cat” and “what is a vat”, where the words ‘hat’, ‘cat’, and ‘vat’ each have a corresponding confidence score. The system can determine a corresponding relatedness score between each of the words ‘hat’, ‘cat’, and ‘vat’ and the further candidate text representation of “with a V” indicating the likelihood each candidate word is related to the further candidate text representation. In some implementations, the system can rescore each of the hypotheses based on the initial confidence scores and the relatedness score. Based on this rescoring, the hypothesis of “what is a vat” can become the top hypothesis, and the system can generate the revised text representation of “what is a vat”

Additionally or alternatively, the system can use a language model in determining whether the further spoken input was provided to correct at least one word in the candidate text representation. For example, a language score, indicating the likelihood of the sequence of words in the candidate text representation, can be generated based on processing the candidate text representation with the language model. A candidate revised text representation can similarly be processed using the language model to generate a further language score indicating the likelihood of the sequence of words in a candidate revised text representation. In some implementations, the system can determine whether the further spoken input was provided to alter the candidate text representation based on comparing the language score with the further language score. For instance, the system can process the candidate text representation of “what is a hat” using the language model to generate a language score of 75, and can process a candidate revised text representation of “what is a vat” using the language model to generate a further language score of 90. Based on comparing the language score of 75 and the further language score of 90, the system can determine the further spoken input of “with a V” was intended to correct the word ‘hat’ in the candidate text representation, and can generate the revised text representation of “what is a vat”.

Accordingly, various implementations set forth techniques for determining whether a user spoke further input to correct a misrecognition of at least one word in a candidate text representation of prior (e.g., immediately preceding) spoken input. For example, the user can speak spoken input of “show me a picture of Liza” and the system can generate a candidate text representation of “show me a picture of Lisa”, where the word ‘Liza’ in the spoken input is misrecognized in the candidate text representation as ‘Lisa’. The user can speak a further spoken utterance of “Liza like Liza the Frog” (where Liza the frog is a childhood cartoon character) to correct the misrecognition of the word ‘Liza’ in the candidate text representation. In some implementations, the system can generate the candidate text representation of spoken input while processing audio data capturing the spoken input using a streaming automatic speech recognition model, where the system can render a transcript of the candidate text representation while the user is still speaking. This can allow the user to view the transcript of the candidate text representation and identify any misrecognitions before the system performs one or more further actions responsive to the candidate text representation.

For instance, the user can identify the misrecognition of ‘Liza’ as ‘Lisa’ in a transcript of the candidate text representation before the system renders a picture of ‘Lisa’ responsive to the candidate text representation of “show me a picture of Lisa”. In various implementations, computing resources (e.g., memory, battery power, processor cycles, etc.) can be conserved by the user correcting the misrecognition of the spoken input without the system resource intensive action(s) in obtaining and/or providing content responsive to the misrecognized spoken input. In contrast, without using techniques described herein, the system would render a picture of ‘Lisa’ responsive to the incorrect candidate text representation of “show me a picture of Lisa” before the user could attempt to correct the misrecognition by repeating the spoken input of “show me a picture of Liza” (which may again be misrecognized) and/or before the user could correct the misrecognition by performing lower-latency typing of “show me a picture of Liza” and/or by performing editing of the misrecognized transcription. Additionally or alternatively, the further spoken input, spoken by the user in response to the misrecognition of the spoken input, may be shorter than repeating the spoken input, thus allowing the user to focus on the part of the spoken input that was misrecognized instead of the entire spoken input. In furtherance of the previous example, when the system misrecognizes the word ‘Liza’ as ‘Lisa’ in the spoken input of “show me a picture of Liza”, the user can speak further spoken input of “no, with a Z”. In various implementations, computing resources can be conserved by processing the shorter further spoken input in comparison to reprocessing the longer spoken input.

More generally, implementations disclosed herein enable a user to provide further spoken input to correct a misrecognition of at least one word in a candidate text representation of prior (e.g., immediately preceding) spoken input of the user. Those implementations enable low-latency correction of a misrecognition and/or prevent the user from needing to utilize an alternate input modality (e.g., a virtual or physical keyboard) to correct a misrecognition. Additionally or alternatively, those implementations provide an improved user/system interaction that enables correction of misrecognition in a manner that is more natural for the user.

The above description is provided only as an overview of some implementations disclosed herein. These and other implementations of the technology are disclosed in additional detail below. It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example dialog session between a user and a client device in accordance with various implementations disclosed herein.

FIG. 2 illustrates another example dialog session between a user and a client device in accordance with various implementations disclosed herein.

FIG. 3A and FIG. 3B illustrate additional example dialog sessions between a user and a client device in accordance with various implementations disclosed herein.

FIG. 4A illustrates an example of generating a revised text representation of spoke input in accordance with various implementations disclosed herein.

FIG. 4B illustrates an example of generating candidate text of further spoken input in accordance with various implementations disclosed herein.

FIG. 5 illustrates an example environment in which various implementations disclosed herein may be implemented.

FIG. 6 is a flowchart illustrating an example in accordance with various implementations disclosed herein.

FIG. 7 illustrates another example environment in which various implementations disclosed herein may be implemented.

FIG. 8 illustrates an example architecture of a computing device.

### DETAILED DESCRIPTION

It is becoming increasingly common for a user to interact with a computing device (e.g., a mobile phone, a standalone interactive speaker, a smart watch, etc.) using speech input. Speech can provide a natural input mechanism for performing a variety of tasks including (but not limited to) searching the web, interacting with a digital assistant, dictating a message, etc. In some implementations, in response to a user providing a spoken utterance, a speech recognition system can transcribe the utterance into text. In some implementations, the speech recognition system can generate several candidate hypotheses of the text representation of the utterance. However, systems will typically only show the top hypothesis (e.g., the first hypothesis) to the user and/or only use the top hypothesis for query interpretation.

In some implementations, the speech recognition system can misrecognize one or more words spoken by the user. For instance, the system can misrecognize one or more words due to short utterance, noisy utterances, and/or due to words and/or entity names sounding similar. In some of those implementations, a user may notice from a streaming transcription of their speech input that the speech recognition output is incorrect. Additionally or alternatively, the user may clarify the misrecognized one or more words during and/or after the query. In some implementations, the user can provide a disambiguation phrase to clarify the misrecognized word(s).

In some implementations, a system can recognize a disambiguation phrase and/or can correct misrecognized spoken input based on the disambiguation phrase. In some implementations, the user can provide the disambiguation phrase along with the speech input as a single utterance. For example, the user can speak “show me a picture of a rat, with an R” as a single utterance, where the user speaks the disambiguation phrase portion, i.e., “with an R”, in response to the system rendering text of “show me a picture of a cat” and/or in response to the system rendering a picture of a cat. Additionally or alternatively, the user can speak the disambiguation phrase as a follow up to a misrecognized query. For example, the user can speak spoken input of “show me a picture of a rat” and subsequently can speak further spoken input of “with an R” in response to the system rendering text of “show me a picture of a cat” and/or in response to the system rendering a picture of a cat.

In some other implementations, in response to the spoken input of “show me a picture of a rat”, the system can render audio output based on synthesized speech of “Did you mean a rat or a cat?”. The user can provide further spoken input of “with an R” in response to the audio output. In other words, the system can provide output requesting further clarification from the user in place of providing output based on a misrecognition.

In some implementations, the user can trigger an assistant and/or some other voice based interface prior to speaking the spoken input. For example, the user can speak an invocation phrase (e.g., Assistant, Hey Assistant, OK Assistant), make a physical gesture (e.g., selecting a physical button, selecting a virtual button, squeezing a device, etc.) to begin a dialog session. The user can then begin speaking the spoken input. As the user speaks the input, the system can generate a candidate text representation of the spoken input by processing audio data capturing the spoken input using an automatic speech recognition (‘ASR’) model. In some of those implementations, the ASR model can be stored locally at the client device. In some other implementations, the ASR model can be stored remote from the client device (e.g., stored remote on a server). In some implementations, the ASR model can be used to generate streaming results, portions of which may be rendered while the user is still speaking. In some implementations, the top hypothesis of the candidate text representation can be rendered while the user continues to speak the spoken input. In some implementations, multiple hypotheses may be parsed (e.g., query parsing) while the user is speaking. Providing the candidate text representation in a streaming manner (i.e., providing word(s) as the system generates the candidate text representation while the user is still speaking) can allow for immediate feedback from the user (e.g., the user can provide immediate feedback on the candidate text representation of each word as they are speaking).

While the user is speaking, the user may identify that one or more words of the spoken input has been misrecognized by the computing system. For instance, while the user is providing spoken input of “call Brad”, the user may identify a misrecognition of the word Brant based on the client device rendering output of “call Brant” to the user. In some implementations, the user can provide further spoken input intended to correct the one or more misrecognized words. In some of those implementations, the user can provide a disambiguation phrase, signaling the system that they are providing a correction. For example, the user can provide further spoken input of “like Brad the Big Green Cat” (where Brad the Big Green Cat is a well-known cartoon cat). In some implementations, the system can process the further spoken input (and/or the audio data capturing the further spoken input) of “like Brad the Big Green Cat” to extract a disambiguation phrase based on grammars, machine learning models, etc. In some implementations, a disambiguation model can be trained to process the further candidate text representation to identify one or more grammars in the further candidate text representation, such as ‘ends with <entity>’, ‘begins with <entity>’, ‘with a <entity>’, ‘like <entity>’, one or more additional or alternative grammars, and/or combinations thereof. Additionally or alternatively, the disambiguation model can be trained to process the further candidate text representation to identify a reference to specific entities (e.g., actors, places, book characters, artists, musicians, one or more alternative specific entities, and/or combinations thereof), and/or other categories (e.g., animal, movie star, food, one or more alternative specific entities, and/or combinations thereof).

In some implementations, once the disambiguation phrase and/or the one or more attributes have been parsed from the further candidate text representation, the system can compare the disambiguation phrase and/or the one or more attributes with the candidate text representation of the spoken input and/or one or more additional hypotheses for the candidate text representation of the spoken input. In some implementations, the system can compare one or more low confidence terms, one or more infrequently used terms, one or more infrequently used entity names, one or more additional terms, and/or combinations thereof, in the candidate text representation of the spoken input with the one or more attributes. Additionally or alternatively, each word in the candidate text representation can have a corresponding confidence score indicating the likelihood the candidate word is the word from the spoken input. The system can compare word(s) in the candidate text representation where the system has a low confidence that the candidate word is the word in the spoken input with the one or more attributes. For example, the system can determine a low confidence of one or more terms in the candidate text representation when the confidence score for a word or phrase is below 80%, below 75%, below 50%, below 25%, below one or more additional threshold values, and/or combinations thereof. The system can generate the revised text representation based on the low confidence term(s) and the one or more attributes.

As an example, the system can generate a candidate text representation of “call Jim” by processing audio data capturing the spoken input of “call Jem”, where ‘Jim’ in the candidate text representation is a misrecognition of the name ‘Jem’ in the spoken input. The system can determine the confidence score corresponding to the word ‘Jim’ in the candidate text representation is below a threshold value, such as below 75%. In response to rendered output of “call Jim”, the user can speak further spoken input of “like Jem the Grouch” (where Jem the Grouch is a well-known television monster). In some implementations, the system can process a further candidate text representation of the further spoken input of “like Jem the Grouch” using a disambiguation model to identify the expression ‘like <entity>’ in the further candidate text representation. Additionally or alternatively, the system can identify one or more attributes based on the portion(s) of the further candidate text representation corresponding to the <entity> portion of the expression. In other words, the system can identify the one or more attributes based on the portion of the further candidate text representation of ‘Jem the Grouch’. Additionally or alternatively, the system can compare the low confidence word ‘Jim’ with the one or more attributes of ‘Jem the Grouch’. In some implementations, the system can determine the revised text representation of the spoken input based on the candidate text representation of “call Jim” and the one or more attributes of “Jem the Grouch” to generate the revised text representation of “call Jem”.

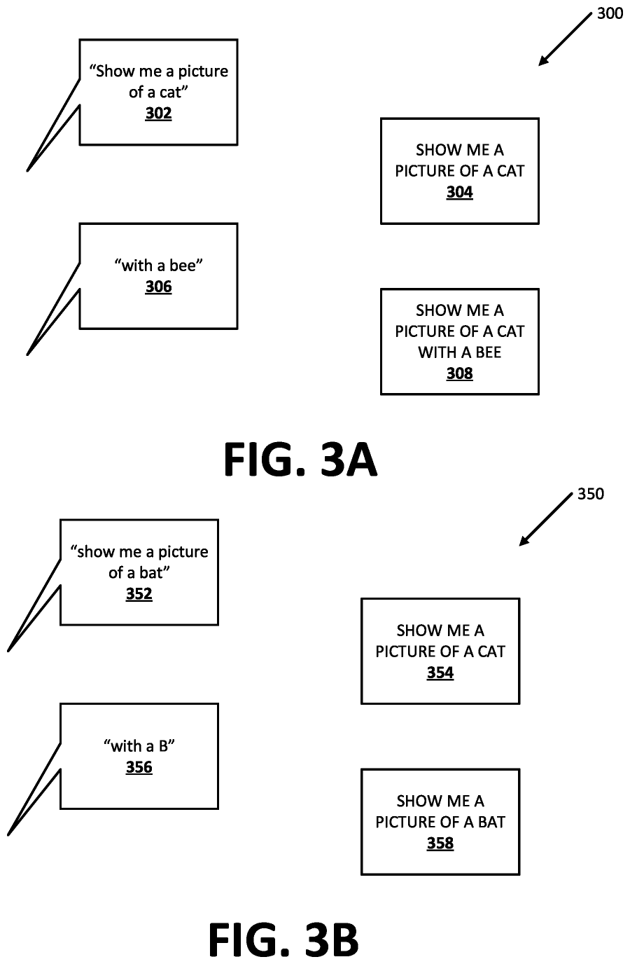

Additionally or alternatively, the system can rescore one or more hypotheses for the candidate text representation to determine whether the one or more attributes are more appropriate than at least one word in the candidate text representation. FIGS. 3A and 3B described herein illustrate examples of determining whether the one or more attributes are more appropriate than the at least one word in the candidate text representation in accordance with various implementations. In some implementations, the system can rescore the one or more hypotheses based on the underlying term confidence score(s) and a relatedness score of the one or more attributes indicating a likelihood the one or more attributes are related to one or more of the hypotheses. Additionally or alternatively, the system can rescore the one or more hypotheses based on a time alignment signal where the user speaks the further spoken input close in time to when the misrecognized word is rendered by the system (e.g., word-by-word rendering, streaming, etc.) and/or can be spoken at a slight delay when referring to several words (e.g., sentence-piece by sentence-piece rendering, streaming, etc.). Furthermore, in some implementations the system can rescore the one or more hypotheses based on a visual signal indicating a location of the transcription and thus a corresponding word of the transcription the user is looking at (e.g., a gaze signal). In other words, the user may look at the misrecognized word while speaking the further spoken input. In some implementations, the confidence score can be used in determining whether the further spoken input was intended to correct at least one word in the spoken input (i.e., whether to use the disambiguation phrase and/or one or more attributes of the disambiguation phrase to generate the revised text representation of the spoken input).

Additionally or alternatively, the system can use a language model in determining whether the further spoken input was provided to correct at least one word in the candidate text representation. For example, a language score indicating the likelihood of the sequence of words in the candidate text representation can be generated based on processing the candidate text representation with the language model. A candidate revised text representation can similarly be processed using the language model to generate a further language score indicating the likelihood of the sequence of words in a candidate revised text representation. In some implementations, the system can determine whether the further spoken input was provided to alter the candidate text representation based on comparing the language score with the further language score. For instance, the system can process the candidate text representation of “what is a hat” using the language model to generate a language score of 75, and can process a candidate revised text representation of “what is a vat” using the language model to generate a further language score of 90. Based on comparing the language score of 75 and the further language score of 90, the system can determine the further spoken input of “with a V” was intended to correct the word ‘hat’ in the candidate text representation, and can generate the revised text representation of “what is a vat”. In some implementations, the system can use one or more additional or alternative models in determining whether the further spoken input was provided to correct at least one word in the candidate text representation, such as: an encoder model and a decoder model, where the candidate text representation of the spoken input and the further candidate text representation of the further spoken input can be processed by the encoder model, and the corresponding decoder output can generate the revised text representation of the spoken input and/or a pointer network which can process the candidate text representation and the further candidate text representation to generate an indication of the revised text representation.

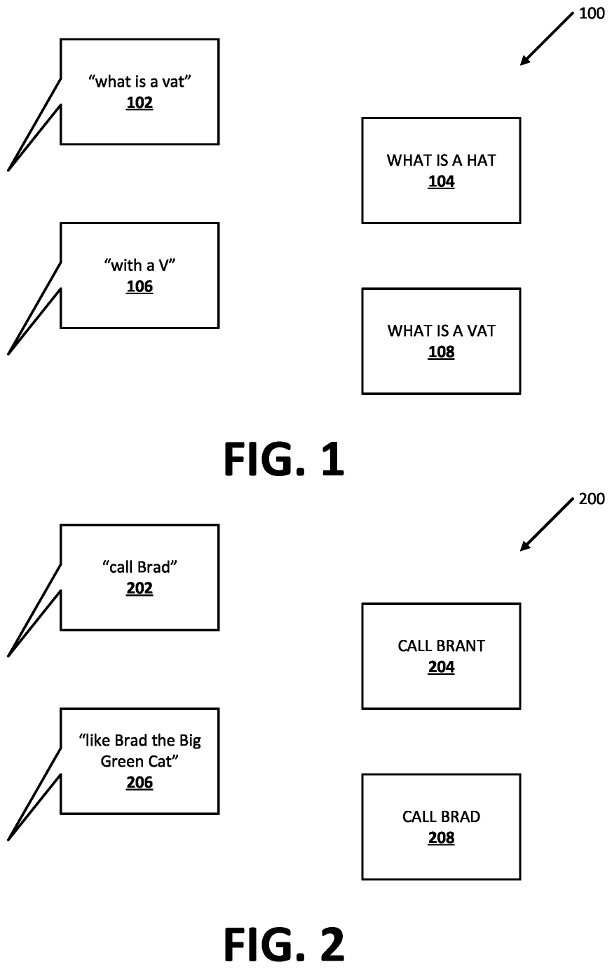

Turning now to the figures, FIGS. 1, 2, 3A, and 3B illustrate examples in accordance with various implementations disclosed herein. FIG. 1 illustrates example 100 in accordance with various implementations. Example 100 illustrates a dialog session between a user and a client device. In some implementations, one or more microphones of the client device can capture audio data, where the audio data captures the spoken input spoken by the user. The client device can include, for example, a mobile phone, a tablet computer, a laptop computer, a desktop computer, a smart watch, a standalone assistant device, one or more client devices, and/or combinations thereof. In the illustrated example, the user speaks spoken input 102 of “what is a vat”. The system can generate a candidate text representation of the spoken input. In some implementations, the system can generate the candidate text representation of the spoken input by processing the audio data capturing the spoken input using an automatic speech recognition (‘ASR’) model. In some implementations, the ASR model can be stored locally at the client device. In some other implementations, the ASR model can be stored remotely from the client device (e.g., stored at a server remote from the client device). Additionally or alternatively, the ASR model can process the audio data and generate the candidate text representation of the spoken input in a streaming manner (e.g., the candidate text representation can be generated and displayed to the user while the user is speaking the spoken input).

For instance, the system can generate a candidate text representation of “what is a hat”, where the word ‘hat’ is a misrecognition in the candidate text representation of the word ‘vat’ captured in the spoken input. In some implementations, the system can render candidate text output 104 of the “WHAT IS A HAT”. In some implementations, the user can see the misrecognition of the word ‘vat’ and can speak further spoken utterance of “with a V” to correct the misrecognition. The system can process the further audio data capturing the further spoken input of “with a V” using the ASR model to generate a further candidate text representation of the further spoken input. Additionally or alternatively, the system can process the further candidate text representation of “with a V” to determine whether the further spoken input was intended to correct the one or more misrecognized words in the candidate text representation of the spoken input. In example 100, the system generates a revised text representation of the spoken input 208 of “WHAT IS A VAT”, where the revised text representation corrects the misrecognition of the word ‘vat’.

FIG. 2 illustrates example 200 in accordance with various implementations. In example 200, the user speaks the spoken input 200 of “call Brad”. The system can generate a candidate text representation of “call Brant”, where the word ‘Brant’ is a misrecognition of the word ‘Brad’ spoken by the user. In some implementations, the user can have a contact stored on the client device for a person named Brad and an additional person named Brant. In some of those implementations, the system can select the name Brant based on the user more frequently contacting Brant than Brad. For instance, if the user contacts Brant daily and has not contacted Brad in 3 years, the system may generate the candidate text representation of “call Brant” due to the increased likelihood the user generally contacts Brant instead of Brad.

In some implementations, the system can render output 204 of “CALL BRANT”, thus enabling the user to identify the misrecognition of the word ‘Brad’. In response to identifying the misrecognition, the user can speak the further spoken input 206 of “like Brad the Big Green Cat” (where Brad the Big Green Cat is a well-known cartoon cat). The system can generate a further candidate text representation of the further spoken input of “like Brad the Big Green Cat”. In some implementations, the further candidate text representation can be processed using a disambiguation model as described herein to identify the further spoken input was provided by the user to correct the misrecognized word ‘Brant’ to ‘Brad’. In response to determining the user spoke the further spoken input 206 of “like Brad the Big Green Cat” in response to determining the misrecognition in the candidate text representation 204 of “CALL BRANT”, the system can generate a revised text representation of the spoken input 208 of “CALL BRAD”, where the revised text representation correct the misrecognition of ‘Brad’.

FIG. 3A illustrates example 300 in accordance with various implementations. In example 300, the user speaks the spoken input 302 of “show me a picture of a cat”. The system can generate a candidate text representation 304 of “SHOW ME A PICTURE OF A CAT”. In example 300, the system does not misrecognize any words in the spoken input of “show me a picture of a cat”. The user can speak further spoken input 306 of “with a bee”. The system can process the further spoken input 306 to generate a further candidate text representation of “with a bee”. In some implementations, the system can process the further candidate text representation of “with a bee” to determine whether the user spoke the further spoken input with the intent of correcting at least one word in the spoken input. In example 300, the system can determine the user did not speak the further spoken input to correct one or more words in the spoken input. In response to determining the user did not speak the further spoken input of “with a bee” to correct one or more words in the spoken input of “show me a picture of a cat”, the system can generate a revised text representation based on the candidate text representation of the spoken input and the further candidate text representation of the further spoken input. In the illustrated example 300, the system can generate the revised text representation 308 of “SHOW ME A PICTURE OF A CAT WITH A BEE”.

In some implementations, the system can determine a confidence score for one or more words in the candidate text representation 304, where the confidence score for each word indicates the likelihood the word is a correct text representation of the corresponding portion of the spoken input. For instance, the system can determine a high confidence score corresponding to the word ‘cat’ in the candidate text representation 304, indicating a high probability the user spoke the word ‘cat’ in the spoken input. In some implementations the system can determine the further spoken input 306 of “with a bee” is not intended as a correction of the word ‘cat’ in the candidate text representation 304 based (at least in part) on the high confidence score of the word cat.

Additionally or alternatively, the system can determine further confidence scores corresponding to words in the further candidate text representation. For instance, the system can determine a high confidence score corresponding to the word ‘bee’ indicating a high probability the user spoke the word ‘bee’ in the further input. Conversely, the user can determine a low confidence score corresponding to the word ‘B’ in an alternative hypothesis of the further candidate text representation. The system can determine the further candidate text representation was not spoken by the user to correct at least one word based on the high confidence score for the word ‘bee’, the low confidence score for the word ‘B’, one or more additional factors, and/or combinations thereof. In the illustrated example, the system can determine the further spoken input was not provided to correct one or more words in the spoken input, and can generate a revised text representation of the spoken input by appending the further spoken input to the end of the spoken input to generate a revised text representation 308 of “SHOW ME A PICTURE OF A CAT WITH A BEE”.

FIG. 3B illustrates example 350 in accordance with various implementations. In example 350, the user speaks the spoken input 352 of “show me a picture of a bat”. The system can generate a candidate text representation of the spoken input 354 of “SHOW ME A PICTURE OF A CAT”, where the word ‘cat’ in the candidate text representation is a misrecognition of the word ‘bat’ in the spoken input. The user can speak further spoken input 356 of “with a B” in response to identifying the system misrecognized the word ‘bat’. In some implementations, the system can generate a further candidate text representation of “with a B” based on the further spoken input 356. In some implementations, the system can process the further candidate text representation of “with a B” to determine the user provided the further spoken input 356 of “with a B” to correct the misrecognized word ‘bat’. In some implementations, the system can generate a revised text representation 358 of “SHOW ME A PICTURE OF A BAT” based on the further candidate text representation of “with a B”.

In some implementations, the system can determine a confidence score for one or more words in the candidate text representation 354, where the confidence score for each word indicates the likelihood the word is a correct text representation of the corresponding portion of the spoken input. For instance, the system can determine a low confidence score corresponding to the word ‘cat’ in the candidate text representation 354, indicating a low probability the user spoke the word ‘cat’ in the spoken input. In some implementations the system can determine the further spoken input 356 of “with a B” is intended as a correction of the word ‘cat’ in the candidate text representation 354 based (at least in part) on the low confidence score of the word cat.

Additionally or alternatively, the system can determine further confidence scores corresponding to words in the further candidate text representation. For instance, the system can determine a high confidence score corresponding to the word ‘B’ indicating a high probability the user spoke the word ‘B’ in the further input. Conversely, the user can determine a low confidence score corresponding to the word ‘bee’ in an alternative hypothesis of the further candidate text representation. The system can determine the further candidate text representation was spoken by the user to correct at least one word based on the low confidence score for the word ‘B’, the low confidence score for the word ‘bee’, one or more additional factors, and/or combinations thereof. In the illustrated example, the system can determine the further spoken input was not provided to correct one or more words in the spoken input, and can generate a revised text representation of the spoken input by altering the word ‘cat’ with the letter ‘B’ to generate the revised text representation 358 of “SHOW ME A PICTURE OF A BAT”.

While the examples 300 and 350 both include the system generating a candidate text representation of spoken input of “SHOW ME A PICTURE OF A CAT” (i.e., candidate text representation 304 and candidate text representation 354), the candidate text representation 354 is a misrecognition of the spoken input 352 of “show me a picture of a bat”, while the candidate text representation 302 is not a misrecognition of the spoken input 302 of “show me a picture of a cat”. Additionally or alternatively, while phonetically similar, the further spoken input of 306 of “with a bee” was not spoken to correct at least one word in the candidate text representation 304, while the further spoken input 356 of “with a B” was spoken to correct at least one word in the candidate text representation 354.

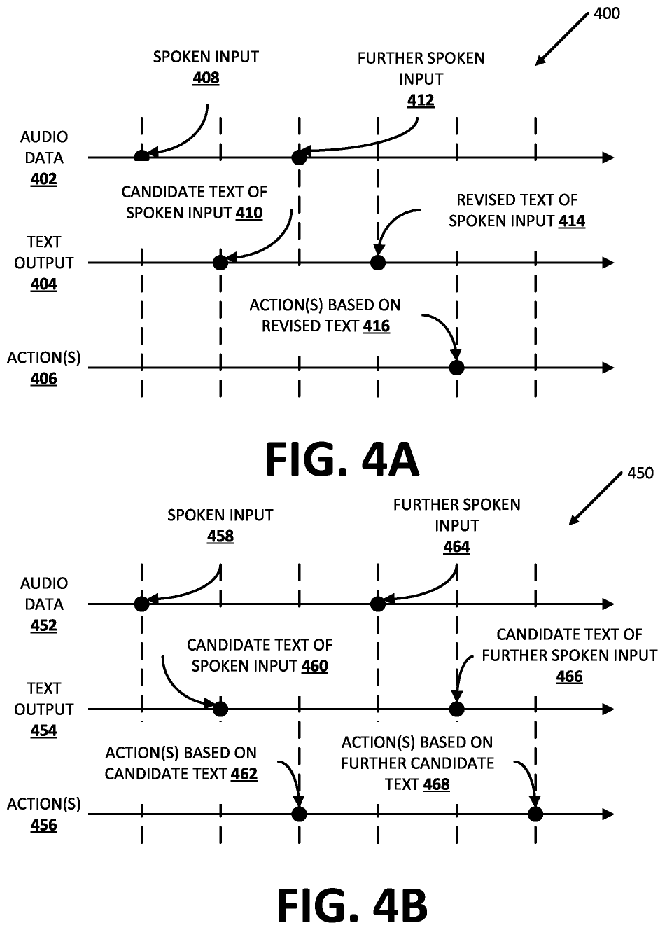

FIG. 4A illustrates an example 400 of generating a revised text representation of spoken input. The illustrated example 400 includes an audio data stream 402, client device text output 404, and one or more actions 406. At point 408, the user provides spoken input. For example, audio data capturing the spoken input by the user can be captured via one or more microphones of the client device. In some implementations, the system can process the audio data capturing the spoken input using an ASR model to generate a candidate text representation of the spoken input. At point 410, the system can render output based on the candidate text representation of the spoken input for the user. For example, the system can render the output based on the candidate text representation via a display of the client device. In some implementations, the candidate text representation can include at least one misrecognized word. At point 412, the user can provide further spoken input intended to correct the misrecognition in the candidate text representation of the spoken input 410. In some implementations, the system can generate a further candidate text representation of the further spoken input. In some of those implementations, the system can determine the further candidate text representation was intended to correct the candidate text representation of the spoken input, and at point 414 can generate a revised text representation of the spoken input based on the further spoken input (e.g., one or more attributes of the further candidate text representation) and the candidate text representation of the spoken input. At point 416, the system can perform one or more actions based on the revised text representation of the spoken input. For instance, the system can render text output for the user based on the revised text representation of the spoken input. For example, as illustrated in FIG. 1, the system can provide responsive content for the user responsive to the revised text representation 108 of “WHAT IS A VAT” without unnecessarily providing response content to the candidate text representation 104 of “WHAT IS A HAT”.

In contrast, FIG. 4B illustrates an example 450 of generating a further candidate text representation of further spoken input without generating the revised text representation as illustrated in FIG. 4A. At point 458, the user provided spoken input, and at point 460, the system generates a candidate text representation of the spoken input. However, at point 462, the system performs one or more actions based on the candidate text representation of the spoken input. In some implementations, the action(s) performed based on the candidate text representation are responsive to a misrecognition of the spoken input and not to the spoken input. In some of those implementations, the action(s) performed at point 462 are a waste of computing resources (e.g., battery power, processor cycles, memory, etc.) since the one or more actions are not responsive to the spoken input. In response to the action(s) based on the candidate text representation which are not responsive to the spoken input, at point 464 the user can provide further spoken input (e.g., repeat the spoken input, reiterating the intent captured in the spoken input but phrased in an alternative way, etc.). At point 466, the system can generate a further candidate text representation of the further spoken input. Additionally or alternatively, the system can perform one or more further actions 468 based on the further candidate text representation of the further spoken input. For example, if the system generates a candidate text representation of “WHAT IS A HAT” based on the spoken input of “what is a vat”, the system may unnecessarily provide content responsive to “WHAT IS A HAT”.

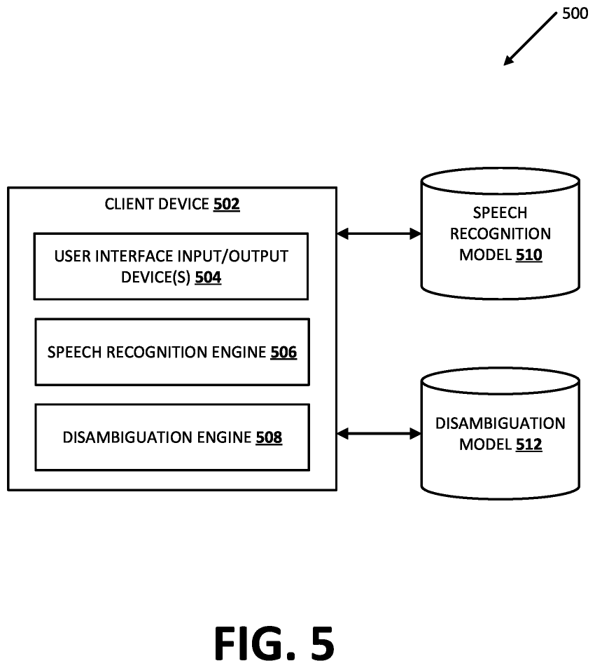

FIG. 5 illustrates a block diagram of an example environment 500 in which various implementations may be implemented. The example environment 500 includes a client device 502 which can include user interface input/output devices 504, speech recognition engine 506, disambiguation engine 508, and/or one or more additional engines (not depicted). Additionally or alternatively, client device 502 may be associated with speech recognition model 510, disambiguation model 512, and/or one or more additional components (not depicted).

In some implementations, client device 502 may include user interface input/output devices 504, which may include, for example, a physical keyboard, a touch screen (e.g., implementing a virtual keyboard or other textual input mechanisms), a microphone, a camera, a display screen, and/or speaker(s). Additionally or alternatively, client device 502 can include a variety of sensors (not depicted) such as an accelerometer, a gyroscope, a Global Positioning System (GPS), a pressure sensor, a light sensor, a distance sensor, a proximity sensor, a temperature sensor, one or more additional sensors, and/or combinations thereof. The user interface input/output devices may be incorporated with one or more client devices 502 of a user. For example, a mobile phone of the user may include the user interface input output devices; a standalone digital assistant hardware device may include the user interface input/output device; a first computing device may include the user interface input device(s) and a separate computing device may include the user interface output device(s); etc. In some implementations, all or aspects of client device 502 may be implemented on a computing system that also contains the user interface input/output devices. In some implementations client device 502 may include an automated assistant (not depicted), and all or aspects of the automated assistant may be implemented on computing device(s) that are separate and remote from the client device that contains the user interface input/output devices (e.g., all or aspects may be implemented “in the cloud”). In some of those implementations, those aspects of the automated assistant may communicate with the computing device via one or more networks such as a local area network (LAN) and/or a wide area network (WAN) (e.g., the Internet).

Some non-limiting examples of client device 502 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, an in-vehicle navigation system), or a wearable apparatus of the user that includes a computing device (e.g., a watch of the user having a computing device, glasses of the user having a computing device, a virtual or augmented reality computing device). Additional and/or alternative computing systems may be provided. Client device 502 may include one or more memories for storage of data and software applications, one or more processors for accessing data and executing applications, and other components that facilitate communication over a network. The operations performed by client device 502 may be distributed across multiple computing devices. For example, computing programs running on one or more computers in one or more locations can be coupled to each other through a network. In some implementations, client device 502 can be a mobile phone with a front facing camera and/or an accelerometer, a smart watch with an accelerometer, a standalone hardware device with a front facing camera, etc.

In some implementations, speech recognition engine 506 can process an audio data stream capturing spoken input, further spoken input, and/or additional spoken input (such as spoken input 102, 202, 302, 352, 408, 458, further spoken input 106, 206, 306, 356, 412, 464, and/or one or more alternative data streams) using speech recognition model 510 to generate a candidate text representation of the corresponding spoken input (e.g., the candidate text representation of the spoken input and/or the further candidate text representation of the further spoken input).

In some implementations, disambiguation engine 508 can process the candidate text representation of the spoken input and the further candidate text representation of the further spoken input (and/or the audio data capturing the spoken input and the further audio data capturing the further spoken input) using disambiguation model 512 to determine whether a user spoke the further input to correct one or more words in the spoken input. In some implementations, a disambiguation model can be trained to process the further candidate text representation to identify one or more grammars in the further candidate text representation, such as ‘ends with <entity>’, ‘begins with <entity>’, ‘with a <entity>’, ‘like <entity>’, one or more additional or alternative grammars, and/or combinations thereof. Additionally or alternatively, the disambiguation model can be trained to processes the further candidate text representation to identify a reference to specific entities (e.g., actors, places, book characters, artists, musicians, one or more alternative specific entities, and/or combinations thereof), and/or other categories (e.g., animal, movie star, food, one or more alternative specific entities, and/or combinations thereof).

In some implementations, once the disambiguation phrase and/or the one or more attributes have been parsed from the further candidate text representation, the system can compare the disambiguation phrase and/or the one or more attributes with the candidate text representation of the spoken input and/or one or more additional hypotheses for the candidate text representation of the spoken input. In some implementations, the system can compare one or more low confidence terms, one or more infrequently used terms, one or more infrequently used entity names, one or more additional terms, and/or combinations thereof, in the candidate text representation of the spoken input with the one or more attributes. Additionally or alternatively, each word in the candidate text representation can have a corresponding confidence score indicating the likelihood the candidate word is the word from the spoken input. The system can compare word(s) in the candidate text representation where the system has a low confidence the candidate word is the word in the spoken input with the one or more attributes. For example, the system can determine a low confidence of one or more terms in the candidate text representation when the confidence score for a word is below 80%, below 75%, below 50%, below 25%, below one or more additional threshold values, and/or combinations thereof. The system can generate the revised text representation based on the low confidence term(s) and the one or more attributes.

Additionally or alternatively, an audio engine (not depicted) can perform one or more actions based on the revised text of the spoken utterance. In some implementations, the system can perform one or more actions based on the revised text of the spoken utterance displaying a transcript of the text representation of the revised text of the spoken utterance; transmitting the revised text representation of the spoken utterance to a natural language understanding (NLU) model; generating a response to the revised text of the spoken utterance; rendering content responsive to the revised text of the spoken utterance (e.g., rendering an audio based response to the revised text of the spoken utterance, rendering image(s) requested by the revised text of the spoken utterance, rendering video requested by the revised text of the spoken utterance, etc.); performing action(s) based on the revised text of the spoken utterance (e.g., controlling a smart device based on the revised text of the spoken utterance, etc.).

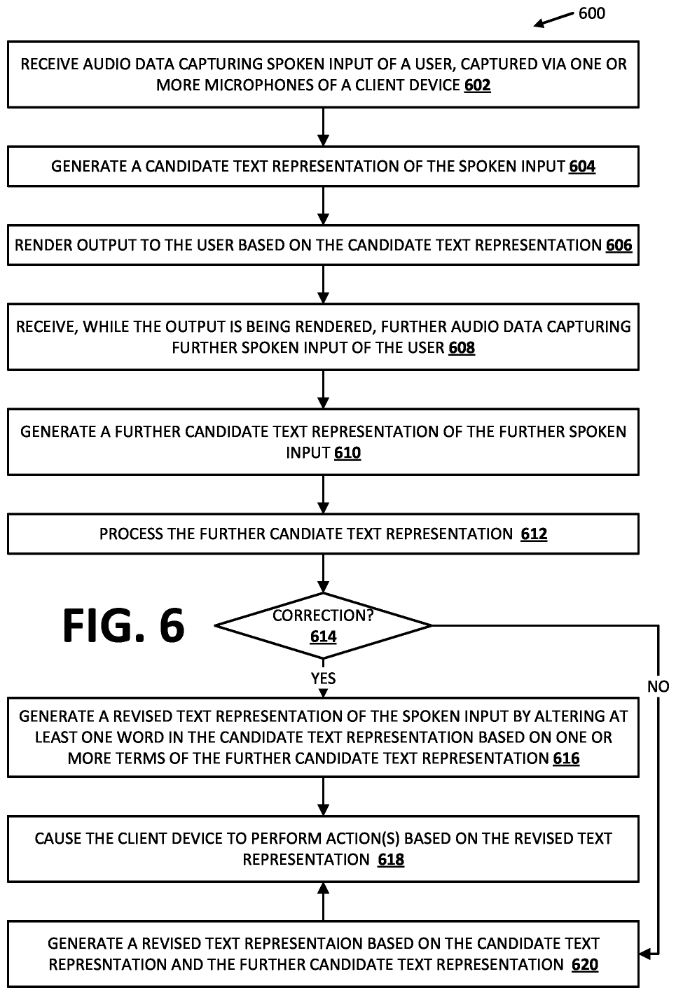

FIG. 6 is a flowchart illustrating an example process of 600 of generating a revised text representation of spoken input in accordance with various implementations disclosed herein. For convenience, the operations of the flowchart are described with reference to a system that performs the operations. This system may include various components of various computer systems, such as one or more components of client device 502, client device 702, and/or computing system 810. Moreover, while operations of process 600 are shown in a particular order, this is not meant to be limiting. One or more operations may be reordered, omitted, and/or added.

At block 602, the system receives audio data capturing spoken input of a user. In some implementations, audio data can be captured via one or more microphones of a client device. For example, the system can receive audio data capturing the spoken input 102 of “what is a vat” as illustrated in FIG. 1; the spoken input 202 of “call Brad” as illustrated in FIG. 2; the spoken input 302 of “show me a picture of a cat” as illustrated in FIG. 3A; the spoken input 352 of “show me a picture of a bat” as illustrated in FIG. 3B; etc.

At block 604, the system can generate a candidate text representation of the spoken input. In some implementations, the system can process the audio data using an automatic speech recognition model, such as speech recognition model 510 of FIG. 5. In some implementations, the speech recognition model can be stored remote from the client device (e.g., stored remote from the client device on a server). In some other implementations, the speech recognition model can be stored locally at the client device. Additionally or alternatively, the speech recognition model can generate streaming results, where the system can generate the candidate text representation of portions of the spoken utterance while the user is speaking the input. For example, while the user is speaking the input of “show me a picture of a cat”, the system can generate a text representation of each word after the user speaks the word while the user is speaking the remaining portion of the utterance. In some implementations, the system can generate a plurality of hypotheses of the candidate text representation of the spoken input, and can select one of those hypotheses (i.e., the top hypothesis) as the candidate text representation of the spoken input.

At block 606, the system can render output to the user based on the candidate text representation of the spoken input. In some implementations, the system can render output based on a first portion of the text representation while the user is continuing the speak the spoken input. For instance, a user can speak a first portion of the spoken input of “show me a”. The system can render a candidate text representation of “show me a” while the user continues to speak the remainder of the utterance of “picture of a cat”. In some implementations, the system can render output based on individual words in the spoken input.

At block 608, while the output is being rendered, the system receives further audio data capturing further spoken input of the user. For example, the system can receive further audio data capturing the further spoken input 106 of “with a V” as illustrated in FIG. 1; the further spoken input 206 of “like Brad the Big Green Cat” as illustrated in FIG. 2; the further spoken input 306 of “with a bee” as illustrated in FIG. 3A; the further spoken input 356 of “with a B” as illustrated in FIG. 3B; etc.

At block 610, the system generates a further candidate text representation of the further spoken input. In some implementations, the system can generate the further candidate text representation using the speech recognition model 510 described herein.

At block 612, the system processes the further candidate text representation. In some implementations, the system can process the further candidate text representation (and/or the audio data capturing the further text representation) using a disambiguation model to determine whether the further candidate text representation includes a disambiguation phrase. In some implementations, the system can parse the further candidate text representation to extract one or more attributes of the further candidate text representation. For example, the system can extract pronunciation cues, knowledge graph entities, one or more additional categories (e.g., not the animal, the movie star), and/or combinations thereof.

At block 614, the system determines whether the further candidate text representation was intended as a correction one at least one word in the candidate text representation. In some implementations, the system can determine whether the further candidate text representation includes a disambiguation phrase. For instance, the system can determine whether the further candidate text representation contains the phrase “like <entity>”, “starts with <entity>”, “ends with <entity>”, “with a <entity>”, one or more additional phrases, and/or combinations thereof. In some implementations, the system can compare the one or more attributes to one or more words in the candidate text representation. For example, the system can identify one or more low confidence words in the candidate text representation and determine whether the one or more attributes would increase the confidence score of the word(s). Additionally or alternatively, the system can rescore one or more of the hypotheses of the candidate text representation of the spoken input (e.g., the system can use a combination of the underlying term confidence and a relatedness score of the one or more attributes to rescore one or more of the hypotheses of the candidate text representation).

As illustrated in FIGS. 3A and 3B, in some implementations the system can compare a confidence score of one or more words in the candidate text representation with a confidence score of one or more attributes in the further candidate text representation. For example, as illustrated in FIG. 3A, a high confidence score corresponding to the word ‘cat’ in the candidate text representation 304 can indicate the further spoken input 306 of “with a bee” was not intended to correct the word ‘cat’ in the candidate text representation 304. Similarly, a high confidence score corresponding the word ‘bee’ and/or a low confidence score corresponding to the word ‘B’ can indicate the user did not intend the further spoken input 306 of “with a bee” to correct one or more portions of the candidate text representation 304 of “show me a picture of a cat”.

As a further example, as illustrated in FIG. 3B, the system can determine a low confidence score corresponding to the word ‘cat’ in the candidate text representation 354 provides an indication the user spoke the further spoken input 356 of “with a B” with the intent to correct the word ‘cat’ in the candidate text representation. Additionally or alternatively, a determined high confidence score corresponding to the word ‘B’ and/or a low confidence score corresponding to the word ‘bee’ can indicate the user did speak the further spoken input 356 of “with a B” to correct the word ‘cat’ in the candidate text representation 354. In some implementations, the system can determine whether the further candidate text representation of the further spoken input was intended to correct at least one word in the candidate text representation in using one or more additional or alternative techniques.

If the system determines the further candidate text representation was provided by the user to correct at least one word in the candidate text representation, the system proceeds to block 616. If the system determines the further candidate text representation was not provided by the user to correct at least one word in the candidate text representation, the system proceeds to block 620.

At block 616, the system generates a revised text representation of the spoken input by altering at least one word in the candidate text representation based on one or more terms of the further candidate text representation. In some implementations, the system can generate the revised text representation by altering the at least one word in the candidate text representation based on the one or more attributes of the further candidate text representation. For example, the system can alter the word ‘HAT’ in the candidate text representation 104 based on the further spoken input 106 of “with a V” to generate the revised text representation 108 of “WHAT IS A VAT” as illustrated in FIG. 1.

At block 618, the system causes the client device to perform one or more actions based on the revised text representation. In some implementations, the system can perform one or more actions based on the revised text representation including displaying a transcript of the revised text representation of the spoken input; transmitting the revised text representation of the spoken input to a natural language understanding (NLU) model; generating a response to the revised text representation of the spoken input; rendering content responsive to the revised text representation of the spoken input (e.g., rendering an audio based response to the revised text representation of the spoken input, rendering image(s) requested by the revised text representation of the spoken input, rendering video requested by the revised text representation of the spoken input, etc.); performing action(s) based on the revised text representation of the spoken input (e.g., controlling a smart device based on the revised text representation of the spoken input, etc.). For example, the system can render a transcript of “WHAT IS A VAT” based on the revised text representation as illustrated in FIG. 1.

At block 620, the system generates a revised text representation based on the candidate text representation and the further candidate text representation. In some implementations, the system can append at least a portion of the further candidate text representation to the candidate text representation. For example, as illustrated in FIG. 3A, the system can generate the revised text representation 308 of “SHOW ME A PICTURE OF A CAT WITH A BEE” based on the spoken input 302 of “show me a picture of a cat” and the further spoken input 306 of “with a bee”.

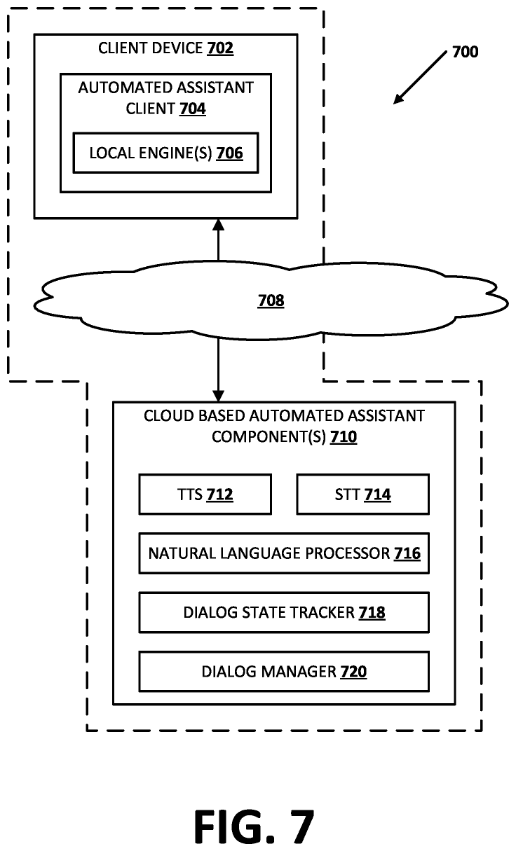

Turning now to FIG. 7, an example environment is illustrated where various implementations can be performed. FIG. 7 is described initially, and includes a client computing device 702, which executes an instance of an automated assistant client 704. One or more cloud-based automated assistant components 710 can be implemented on one or more computing systems (collectively referred to as a “cloud” computing system) that are communicatively coupled to client device 702 via one or more local and/or wide area networks (e.g., the Internet) indicated generally at 708.

An instance of an automated assistant client 704, by way of its interactions with one or more cloud-based automated assistant components 710, may form what appears to be, from the user's perspective, a logical instance of an automated assistant 700 with which the user may engage in a human-to-computer dialog. An instance of such an automated assistant 700 is depicted in FIG. 7. It thus should be understood that in some implementations, a user that engages with an automated assistant client 704 executing on client device 702 may, in effect, engage with his or her own logical instance of an automated assistant 700. For the sakes of brevity and simplicity, the term “automated assistant” as used herein as “serving” a particular user will often refer to the combination of an automated assistant client 704 executing on a client device 702 operated by the user and one or more cloud-based automated assistant components 710 (which may be shared amongst multiple automated assistant clients of multiple client computing devices). It should also be understood that in some implementations, automated assistant 700 may respond to a request from any user regardless of whether the user is actually “served” by that particular instance of automated assistant 700.

The client computing device 702 may be, for example: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device). Additional and/or alternative client computing devices may be provided. In various implementations, the client computing device 702 may optionally operate one or more other applications that are in addition to automated assistant client 704, such as a message exchange client (e.g., SMS, MMS, online chat), a browser, and so forth. In some of those various implementations, one or more of the other applications can optionally interface (e.g., via an application programming interface) with the automated assistant 700, or include their own instance of an automated assistant application (that may also interface with the cloud-based automated assistant component(s) 710).

Automated assistant 700 engages in human-to-computer dialog sessions with a user via user interface input and output devices of the client device 702. To preserve user privacy and/or to conserve resources, in many situations a user must often explicitly invoke the automated assistant 700 before the automated assistant will fully process a spoken utterance. The explicit invocation of the automated assistant 700 can occur in response to certain user interface input received at the client device 702. For example, user interface inputs that can invoke the automated assistant 700 via the client device 702 can optionally include actuations of a hardware and/or virtual button of the client device 702. Moreover, the automated assistant client can include one or more local engines 706, such as an invocation engine that is operable to detect the presence of one or more spoken invocation phrases. The invocation engine can invoke the automated assistant 700 in response to detection of one of the spoken invocation phrases. For example, the invocation engine can invoke the automated assistant 700 in response to detecting a spoken invocation phrase such as “Hey Assistant,” “OK Assistant”, and/or “Assistant”. The invocation engine can continuously process (e.g., if not in an “inactive” mode) a stream of audio data frames that are based on output from one or more microphones of the client device 702, to monitor for an occurrence of a spoken invocation phrase. While monitoring for the occurrence of the spoken invocation phrase, the invocation engine discards (e.g., after temporary storage in a buffer) any audio data frames that do not include the spoken invocation phrase. However, when the invocation engine detects an occurrence of a spoken invocation phrase in processed audio data frames, the invocation engine can invoke the automated assistant 700. As used herein, “invoking” the automated assistant 700 can include causing one or more previously inactive functions of the automated assistant 700 to be activated. For example, invoking the automated assistant 700 can include causing one or more local engines 706 and/or cloud-based automated assistant components 710 to further process audio data frames based on which the invocation phrase was detected, and/or one or more following audio data frames (whereas prior to invoking no further processing of audio data frames was occurring).

The one or more local engine(s) 806 of automated assistant 700 are optional, and can include, for example, the disambiguation engine described above, a local voice-to-text (“STT”) engine (that converts captured audio to text), a local text-to-speech (“TTS”) engine (that converts text to speech), a local natural language processor (that determines semantic meaning of audio and/or text converted from audio), and/or other local components. Because the client device 702 is relatively constrained in terms of computing resources (e.g., processor cycles, memory, battery, etc.), the local engines 706 may have limited functionality relative to any counterparts that are included in cloud-based automated assistant components 710.

Cloud-based automated assistant components 710 leverage the virtually limitless resources of the cloud to perform more robust and/or more accurate processing of audio data, and/or other user interface input, relative to any counterparts of the local engine(s) 706. Again, in various implementations, the client device 702 can provide audio data and/or other data to the cloud-based automated assistant components 710 in response to the invocation engine detecting a spoken invocation phrase, or detecting some other explicit invocation of the automated assistant 700.

The illustrated cloud-based automated assistant components 710 include a cloud-based TTS module 712, a cloud-based STT module 714, a natural language processor 716, a dialog state tracker 718, and a dialog manager 720. In some implementations, one or more of the engines and/or modules of automated assistant 700 may be omitted, combined, and/or implemented in a component that is separate from automated assistant 700. Further, in some implementations automated assistant 700 can include additional and/or alternative engines and/or modules. Cloud-based STT module 714 can convert audio data into text, which may then be provided to natural language processor 716.

Cloud-based TTS module 712 can convert textual data (e.g., natural language responses formulated by automated assistant 700) into computer-generated speech output. In some implementations, TTS module 712 may provide the computer-generated speech output to client device 702 to be output directly, e.g., using one or more speakers. In other implementations, textual data (e.g., natural language responses) generated by automated assistant 700 may be provided to one of the local engine(s) 706, which may then convert the textual data into computer-generated speech that is output locally.

Natural language processor 716 of automated assistant 700 processes free form natural language input and generates, based on the natural language input, annotated output for use by one or more other components of the automated assistant 700. For example, the natural language processor 716 can process natural language free-form input that is textual input that is a conversion, by STT module 714, of audio data provided by a user via client device 702. The generated annotated output may include one or more annotations of the natural language input and optionally one or more (e.g., all) of the terms of the natural language input.

In some implementations, the natural language processor 716 is configured to identify and annotate various types of grammatical information in natural language input. In some implementations, the natural language processor 716 may additionally and/or alternatively include an entity tagger (not depicted) configured to annotate entity references in one or more segments such as references to people (including, for instance, literary characters, celebrities, public figures, etc.), organizations, locations (real and imaginary), and so forth. In some implementations, the natural language processor 716 may additionally and/or alternatively include a coreference resolver (not depicted) configured to group, or “cluster,” references to the same entity based on one or more contextual cues. For example, the coreference resolver may be utilized to resolve the term “there” to “Hypothetical Café” in the natural language input “I liked Hypothetical Café last time we ate there.” In some implementations, one or more components of the natural language processor 716 may rely on annotations from one or more other components of the natural language processor 716. In some implementations, in processing a particular natural language input, one or more components of the natural language processor 716 may use related prior input and/or other related data outside of the particular natural language input to determine one or more annotations.

In some implementations, dialog state tracker 718 may be configured to keep track of a “dialog state” that includes, for instance, a belief state of a one or more users' goals (or “intents”) over the course of a human-to-computer dialog session and/or across multiple dialog sessions. In determining a dialog state, some dialog state trackers may seek to determine, based on user and system utterances in a dialog session, the most likely value(s) for slot(s) that are instantiated in the dialog. Some techniques utilize a fixed ontology that defines a set of slots and the set of values associated with those slots. Some techniques additionally or alternatively may be tailored to individual slots and/or domains. For example, some techniques may require training a model for each slot type in each domain.

Dialog manager 720 may be configured to map a current dialog state, e.g., provided by dialog state tracker 718, to one or more “responsive actions” of a plurality of candidate responsive actions that are then performed by automated assistant 700. Responsive actions may come in a variety of forms, depending on the current dialog state. For example, initial and midstream dialog states that correspond to turns of a dialog session that occur prior to a last turn (e.g., when the ultimate user-desired task is performed) may be mapped to various responsive actions that include automated assistant 700 outputting additional natural language dialog. This responsive dialog may include, for instance, requests that the user provide parameters for some action (i.e., fill slots) that dialog state tracker 718 believes the user intends to perform. In some implementations, responsive actions may include actions such as “request” (e.g., seek parameters for slot filling), “offer” (e.g., suggest an action or course of action for the user), “select,” “inform” (e.g., provide the user with requested information), “no match” (e.g., notify the user that the user's last input is not understood), a command to a peripheral device (e.g., to turn off a light bulb), and so forth.

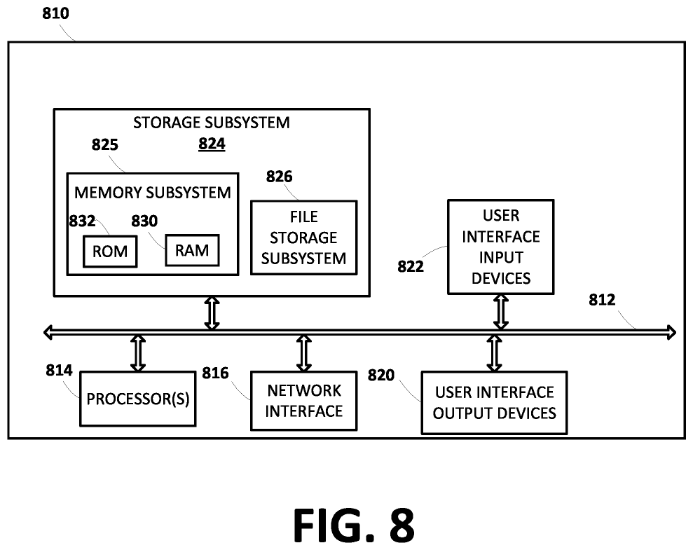

FIG. 8 is a block diagram of an example computing device 810 that may optionally be utilized to perform one or more aspects of techniques described herein. In some implementations, one or more of a client computing device, and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of one or more of the processes of FIG. 6, as well as to implement various components depicted in FIG. 7 and/or FIG. 7.

These software modules are generally executed by processor 814 alone or in combination with other processors. Memory 825 used in the storage subsystem 824 can include a number of memories including a main random access memory (“RAM”) 830 for storage of instructions and data during program execution and a read only memory (“ROM”) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method includes receiving audio data capturing spoken input of a user, where the audio data is captured via one or more microphones of a client device. In some implementations, the method further includes generating a candidate text representation of the spoken input. In some implementations, the method further includes rendering output, to the user, that is based on the candidate text representation. In some implementations, the method further includes receiving, while the output is being rendered, further audio data capturing further spoken input of the user. In some implementations, the method further includes generating a further candidate text representation of the further spoken input. In some implementations, the method further includes determining, based on processing the further candidate text representation, whether the further spoken input is intended as a correction of at least one word in the candidate text representation of the spoken input. In some implementations, in response to determining the further spoken input is intended as the correction, the method further includes generating a revised text representation of the spoken input, wherein generating the revised text representation comprises altering the at least one word in the candidate text representation based on one or more terms of the further candidate text representation. In some implementations, the method further includes causing the client device to perform one or more actions based on the revised text representation.

These and other implementations of the technology can include one or more of the following features.

In some implementations, causing the client device to perform the one or more actions based on the revised text representation includes rendering further output based on the revised text representation.

In some implementations, in response to determining the further spoken input is not intended as a correction of the at least one word in the candidate text representation of the spoken input, the method further includes generating an alternative revised text representation of the spoken input, wherein generating the alternative revised text representation of the spoken input comprises appending one or more terms of the further candidate text representation to the candidate text representation. In some implementations, the method further includes causing the client device to perform one or more alternative actions based on the alternative revised text representation.

In some implementations, in response to determining the further spoken input is not intended as a correction of the at least one word in the candidate text representation of the spoken input, the method further includes causing the client device to perform one or more further actions based on the further candidate text representation of the further spoken input.

In some implementations, the candidate text representation of the spoken input is generated by processing the spoken input using a streaming automatic speech recognition model. In some of those implementations, the further candidate text representation of the further spoken input is generated by processing the further spoken input using the streaming automatic speech recognition model. In some versions of those implementations, the streaming automatic speech recognition model is stored locally at the client device.

In some implementations, prior to receiving the further audio data capturing the further spoken input, the method further includes determining, based on a generated endpointing measure, that the spoken input is complete, wherein the further audio data, capturing the further spoken input, is received after determining the spoken input is complete.

In some implementations, the method further includes receiving the further audio data capturing the further spoken input occurs without determining, based on a generated endpointing measure, that the spoken input is complete.

In some implementations, generating the candidate text representation of the spoken input includes generating a plurality of hypotheses of the candidate text representation, and selecting the candidate text representation from the plurality of hypotheses. In some versions of those implementations, processing the further candidate text representation includes parsing the further candidate text representation using a disambiguation model to extract one or more attributes of the further candidate text representation. In some versions of those implementations, the one or more attributes include a pronunciation cue indicating a pronunciation of the at least one word in the candidate text representation. In some versions of those implementations, the one or more attributes include a knowledge graph entity indicating a relationship between the at least one word in the candidate text representation and the one or more attributes. In some versions of those implementations, the method further includes determining the correction of the at least one word in the candidate text representation based on comparing the one or more attributes with the plurality of hypotheses of the text representation. In some versions of those implementations, determining the correction of the at least one word in the candidate text representation based on comparing the one or more attributes with the plurality of hypotheses of the text representation includes identifying one or more low confidence words in the plurality of the hypotheses of the text representation. In some implementations, the method further includes determining based on the one or more attributes, whether to increase or decrease the confidence of the one or more low confidence words. In some implementations, in response to determining at least one of the attributes increases the confidence of at least one of the low confidence words, the method further includes determining the correction of the at least one word based on the at least one attribute. In some versions of those implementations, determining the correction of the at least one word in the candidate text representation based on comparing the one or more attributes with the plurality of hypotheses of the text representation includes rescoring one or more of the hypotheses of the text representation based on the one or more attributes, and determining the correction of the at least one word based on the rescoring. In some versions of those implementations, altering the at least one word in the candidate text representation based on one or more terms of the further candidate text representation to generate the revised text representation includes processing the candidate text representation using a language model to generate a language score indicating the likelihood of the sequence of words in the candidate text representation. In some implementations, the method further includes identifying, based on the one or more attributes, at least one additional hypothesis of the candidate text representation in the plurality of hypotheses of the candidate text representation. In some implementations, the method further includes processing the at least one additional hypothesis using the language model to generate an additional language score indicating the likelihood of the sequence of words in the additional hypothesis of the candidate text representation. In some implementations, the method further includes comparing the language score and the additional language score. In some implementations, the method further includes determining whether the at least one additional hypothesis is more likely than the candidate text representation based on comparing the language score and the additional language score. In some implementations, in response to determining the at least one additional hypothesis is more likely than the candidate text representation, the method further includes generating the revised text representation altering the at least one word in the candidate text representation based on at least one additional hypothesis.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the methods described herein. Some implementations also include one or more transitory or non-transitory computer readable storage media storing computer instructions executable by one or more processors to perform any of the methods described herein.

What is claimed is:

1. A method implemented by one or more processors, the method comprising:
receiving audio data capturing spoken input of a user, where the audio data is captured via one or more microphones of a client device;
generating a candidate text representation of the spoken input;
rendering output, to the user, that is based on the candidate text representation;
receiving, while the output is being rendered, further audio data capturing further spoken input of the user;
generating a further candidate text representation of the further spoken input;
determining, based on processing the further candidate text representation, whether the further spoken input is intended as a correction of at least one word in the candidate text representation of the spoken input;
in response to determining the further spoken input is intended as the correction:
generating a revised text representation of the spoken input, wherein generating the revised text representation comprises altering the at least one word in the candidate text representation based on one or more terms of the further candidate text representation; and
causing the client device to perform one or more actions based on the revised text representation.

2. The method of claim 1, wherein causing the client device to perform the one or more actions based on the revised text representation comprises rendering further output based on the revised text representation.

3. The method of claim 1, further comprising:
in response to determining the further spoken input is not intended as a correction of the at least one word in the candidate text representation of the spoken input:
generating an alternative revised text representation of the spoken input, wherein generating the alternative revised text representation of the spoken input comprises appending one or more terms of the further candidate text representation to the candidate text representation; and
causing the client device to perform one or more alternative actions based on the alternative revised text representation.

4. The method of claim 1, further comprising:
in response to determining the further spoken input is not intended as a correction of the at least one word in the candidate text representation of the spoken input:
causing the client device to perform one or more further actions based on the further candidate text representation of the further spoken input.

5. The method of claim 1, wherein the candidate text representation of the spoken input is generated by processing the spoken input using a streaming automatic speech recognition model, and wherein the further candidate text representation of the further spoken input is generated by processing the further spoken input using the streaming automatic speech recognition model.

6. The method of claim 5, wherein the streaming automatic speech recognition model is stored locally at the client device.

7. The method of claim 1, further comprising:
prior to receiving the further audio data capturing the further spoken input, determining, based on a generated endpointing measure, that the spoken input is complete;
wherein the further audio data, capturing the further spoken input, is received after determining the spoken input is complete.

8. The method of claim 1, wherein receiving the further audio data capturing the further spoken input occurs without determining, based on a generated endpointing measure, that the spoken input is complete.

9. The method of claim 1, wherein generating the candidate text representation of the spoken input comprises:
generating a plurality of hypotheses of the candidate text representation, and
selecting the candidate text representation from the plurality of hypotheses.

10. The method of claim 9, wherein processing the further candidate text representation comprises:
parsing the further candidate text representation using a disambiguation model to extract one or more attributes of the further candidate text representation.

11. The method of claim 10, wherein the one or more attributes include a pronunciation cue indicating a pronunciation of the at least one word in the candidate text representation.

12. The method of claim 10, wherein the one or more attributes include a knowledge graph entity indicating a relationship between the at least one word in the candidate text representation and the one or more attributes.

13. The method of claim 10, further comprising:
determining the correction of the at least one word in the candidate text representation based on comparing the one or more attributes with the plurality of hypotheses of the text representation.

14. The method of claim 13, wherein determining the correction of the at least one word in the candidate text representation based on comparing the one or more attributes with the plurality of hypotheses of the text representation comprises:
identifying one or more low confidence words in the plurality of the hypotheses of the text representation;
determining based on the one or more attributes, whether to increase or decrease the confidence of the one or more low confidence words; and
in response to determining at least one of the attributes increases the confidence of at least one of the low confidence words, determining the correction of the at least one word based on the at least one attribute.

15. The method of claim 13, wherein determining the correction of the at least one word in the candidate text representation based on comparing the one or more attributes with the plurality of hypotheses of the text representation comprises:
rescoring one or more of the hypotheses of the text representation based on the one or more attributes; and
determining the correction of the at least one word based on the rescoring.

16. The method of claim 10, wherein altering the at least one word in the candidate text representation based on one or more terms of the further candidate text representation to generate the revised text representation comprises:
processing the candidate text representation using a language model to generate a language score indicating the likelihood of the sequence of words in the candidate text representation;
identifying, based on the one or more attributes, at least one additional hypothesis of the candidate text representation in the plurality of hypotheses of the candidate text representation;
processing the at least one additional hypothesis using the language model to generate an additional language score indicating the likelihood of the sequence of words in the additional hypothesis of the candidate text representation;
comparing the language score and the additional language score;
determining whether the at least one additional hypothesis is more likely than the candidate text representation based on comparing the language score and the additional language score; and
in response to determining the at least one additional hypothesis is more likely than the candidate text representation, generating the revised text representation altering the at least one word in the candidate text representation based on at least one additional hypothesis.

17. A client device, comprising:
one or more processors, and
memory configured to store instructions that, when executed by the one or more processors, cause the one or more processors to perform a method that includes:
receiving audio data capturing spoken input of a user, where the audio data is captured via one or more microphones of the client device;
generating a candidate text representation of the spoken input;
rendering output, to the user, that is based on the candidate text representation;
receiving, while the output is being rendered, further audio data capturing further spoken input of the user;
generating a further candidate text representation of the further spoken input;
determining, based on processing the further candidate text representation, whether the further spoken input is intended as a correction of at least one word in the candidate text representation of the spoken input;
in response to determining the further spoken input is intended as the correction:
generating a revised text representation of the spoken input, wherein generating the revised text representation comprises altering the at least one word in the candidate text representation based on one or more terms of the further candidate text representation; and
causing the client device to perform one or more actions based on the revised text representation.

18. The client device of claim 17, wherein causing the client device to perform the one or more actions based on the revised text representation comprises rendering further output based on the revised text representation.

19. The client device of claim 17, wherein the instructions further include:
in response to determining the further spoken input is not intended as a correction of the at least one word in the candidate text representation of the spoken input:
generating an alternative revised text representation of the spoken input, wherein generating the alternative revised text representation of the spoken input comprises appending one or more terms of the further candidate text representation to the candidate text representation; and
causing the client device to perform one or more alternative actions based on the alternative revised text representation.

20. The client device of claim 17, wherein the candidate text representation of the spoken input is generated by processing the spoken input using a streaming automatic speech recognition model, and wherein the further candidate text representation of the further spoken input is generated by processing the further spoken input using the streaming automatic speech recognition model.
